(19) United States
(12) Patent Application Publication
(10) Pub. No.: US 2006/0056827 A1
(43) Pub. Date: Mar. 16, 2006

(54) Lens-fitted photo film unit and method of producing photographic print

(75) Inventor: Takeshi Masuda, Minami-Ashigara-Shi (JP)

Correspondence Address: YOUNG & THOMPSON, 745 SOUTH 23RD STREET, 2ND FLOOR, ARLINGTON, VA, 22202, US

(73) Assignee: FUJI PHOTO FILM CO., LTD., MINAMI-ASHIGARA-SHI (JP)

(21) Appl. No.: 11/224,137

(22) Filed: Sep. 13, 2005

(30) Foreign Application Priority Data
Sep. 13, 2004 (JP) 2004-265793

(51) Int. Cl. G03B 15/03

(52) U.S. Cl. 396/6; 396/176; 396/210

(57) ABSTRACT

In a photo film loaded in a lens-fitted photo film unit, a bar code is recorded at the time of manufacturing. The bar code represents various kinds of information, including known film type information. The film type information further contains flashless information, which indicates that the photo film is for the photography without emitting flash light. In printing, the bar code visualized by developing is read by a printer. When the photo film is judged that the flashless information is provided, a color correction is performed with using the LUT of the color correction specified for a flashless photography.

### BACKGROUND OF THE INVENTION

1. Field of the Invention

The present invention relates to a lens-fitted photo film unit and a method of producing a photographic print.

2. Description Related to the Prior Art

Various types of lens-fitted photo film units in which a photo film is preloaded are commercially available. There is a lens-fitted photo film unit of a built-in flash type. In this type, a flashlight emitting unit is incorporated, so as to make it possible to photograph in dark conditions, such as indoors. Also, there is a mode changeover type, which can respond to shooting scenes with various kinds of luminance by selecting a photography mode corresponding to a photography condition.

In the mode changeover type said above, there is a photo film unit which improves the descriptiveness of the background, in photographing indoors or in dark conditions at night, by using a high-speed photo film. For example, as for “Night & Day (trade name)”, which is a lens-fitted photo film unit manufactured and sold by the applicant, the photo film of an ISO 1600 type is used, and the photo film unit comprises three photography modes. The first is a daylight photography mode (without emitting flash light) corresponding to photographing in bright light, as the outdoors in daytime. The second is a daylight sync photography mode (with emitting flashlight). And the third is a night scene sync photography mode, corresponding to photographing such a dark subject as a night view, or such a main subject as people against background night scenes or dark indoors with use of flash light, for reproducing the background at the proper density.

In photographing by using the flash light emitting unit, because the illuminated main subject loses the shade, or flash light defeats the light source color of the background, it is likely to give a similar impression of being monotonous to any photograph. However, the flash light ensures the sufficient luminance for the main subject like people. Also, in photographing without using the flashlight emitting unit, though there is a problem of causing an underexposure, it is possible to obtain the excellent printed image which has natural brightness and coloring of the background and the main subject, with use of available light.

There is a digital printer, wherein an image sensor such as a charge coupled device (CCD) reads a photographic image on the photo film, then, a photographic print is produced by printing an image on a photographic paper on the basis of an image data obtained by the reading. In the digital printer, there is such a type that pre-reads all the frames on the photo film prior to printing on the photographic paper, and determines the exposure value for printing of red light, green light and blue light by calculating with the result of the pre-reading. This determination of the exposure value means, namely, a color correction and a density correction.

However, when the photography is performed without using the flashlight emitting unit, each photographic image on the photo film has a color dependent on the available light of each shooting scene. Thus, two kinds of the photographic images are mixed in the photo film. One is the photographed image, which has an unbalanced color according to each kind of the artificial light source, such as tungsten light source, fluorescent lamp and the like. The other is the photographed image, which has a standard color by photographing outdoors in daylight. Therefore, in performing a color correction in such a manner as described above, because of equalizing the photographed images in one photo film by the digital printer in order to determine the correction value, when there are a number of the photo images with the unbalanced color in one photo film, the correction value becomes larger. Consequently, a problem occurs that while a photographic print properly color-corrected can be produced from the photographed image with the unbalanced color, a photographic print with the unbalanced color is produced by the excessive color correction to the image photographed outdoors in daylight, which is to have standard color originally. Also, there is another problem that a photographic print corrected to have a standard color is produced, even if the user intends to obtain a photograph with utilizing the color according to available light.

### SUMMARY OF THE INVENTION

In view of the foregoing problems, an object of the present invention is to provide a lens-fitted photo film unit and a method of producing a photographic print, wherein a proper color correction is applied for producing a photographic print from an image photographed without using a flashlight emitting unit.

In order to achieve the above and other objects and advantages of this invention, a lens-fitted photo film unit comprises flashless information which is optically prerecorded outside an exposure area on a photo film being loaded in a unit body containing no flashlight emitting unit at the time of manufacturing, for indicating that the photo film is for photography without using the flashlight emitting unit.

In the embodiment of the present invention, the flashless information is recorded with a bar code. Also, in another embodiment, it is recorded with a dot mark.

In the lens-fitted photo film unit of the present invention, the photo film has the film sensitivity of ISO 1600 or higher. Also, in the more preferable embodiment, the film sensitivity is ISO 3200 or higher.

In a method of producing a photographic print from a photo film by a printer according to the present invention, the flashless information recorded on the photo film, for indicating that the photo film is for the photography without using the flashlight emitting unit, is searched. Then, a predetermined color correction for the flashless photography is performed when the flashless information is detected. Also, a color correction is performed with using a predetermined conversion table of the color correction for the flashless photography when the flashless information is detected.

According to the present invention, the flashless information, for indicating that the photo film is for the photography without using the flashlight emitting unit, is prerecorded on the photo film loaded in the lens-fitted photo film unit not containing the flashlight emitting unit. Therefore, based on the flashless information, a proper color correction for the flashless photography can be readily performed for producing a photographic print. Also, regardless of the kind of the available light source, the image photographed by the lens-fitted photo film unit of the present invention is applied only the fundamental color correction in accordance with the characteristics of the photo film, to produce a photographic print. Hence, even if the image photographed under the artificial light source and the image photographed outdoors in daylight are mixed in one photo film, the image photographed outdoors in daylight can be reproduced with the original standard color on a photographic print.

Besides, according to the present method of producing the photographic print from the photo film by the printer, the predetermined color correction for the flashless photography or the color correction with the predetermined conversion table of the color correction for the flashless photography are performed when the flashless information is detected. Consequently, it is possible to perform a proper color correction for the flashless photography, with low workload on the producing operation of the photographic print, and keeping workability.

### BRIEF DESCRIPTION OF THE DRAWINGS

The above objects and advantages of the present invention will become more apparent from the following detailed description when read in connection with the accompanying drawings, in which:

FIG. 1 is a perspective view illustrating a lens-fitted photo film unit in a first photography mode;

FIG. 2 is a perspective view illustrating the lens-fitted photo film unit in a second photography mode;

FIG. 3 is an exploded perspective view illustrating a constitution of the lens-fitted photo film unit;

FIG. 4 is an exploded perspective view illustrating a constitution of a stop changeover mechanism and a shutter speed shifting mechanism;

FIG. 5A is an explanatory view, partially cutaway, illustrating a bar code recorded on the photo film, FIG. 5B is an explanatory view illustrating a plurality of the bar codes recorded on the photo film;

FIG. 6 is a block diagram illustrating a constitution of a digital printer;

FIG. 7 is a flow chart of processes from manufacturing the lens-fitted photo film unit to producing a photographic print; and

FIG. 8 is a plan view, partially cutaway, illustrating an example of recorded flashless information with a dot mark.

### DETAILED DESCRIPTION OF THE PREFERRED EMBODIMENT(S) OF THE PRESENT INVENTION

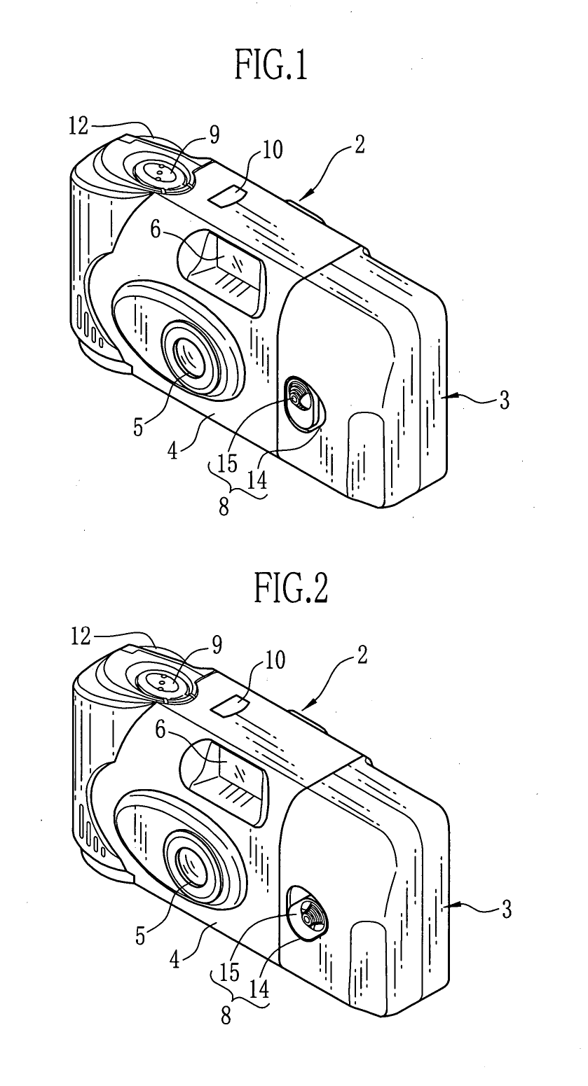

As shown in FIG. 1, a lens-fitted photo film unit 2 is constituted by a unit body 3 in which various kinds of photographic mechanisms are incorporated, a film cartridge loaded in the unit body 3 at the time of manufacturing, and a label 4 attached to wrap the outside of the unit body 3. On the label 4, openings are formed to expose each section of the unit body 3.

The lens-fitted photo film unit 2 is not provided with a flashlight emitting unit applying assist light to a subject for the photography, such as a flash lamp, a light emitting diode (LED), or the like. To a front face of the unit body 3, a taking lens 5, a finder 6, and a photography mode selection device 8 are attached. On an upper face of unit body 3, a shutter release button 9 and a counter window 10 are disposed. A rear surface of the unit body 3 partially exposes a winding wheel 12 for winding up the exposed photo film.

The photography mode selection device 8 is constituted by an operation opening 14 formed on the front face of the unit body 3, and an operation member 15 in a substantially ellipse shape pivotable within the operation opening 14. The operation member 15 is moved between a first operating position depicted in FIG. 1 and a second operating position depicted in FIG. 2, below the first operating position in the clockwise direction of the drawing.

By moving the operation member 15, it is possible to select one of a first photography mode and a second photography mode. The first photography mode has a small aperture and a high shutter speed corresponding to the photography in bright light condition like the outdoors in daytime. The second photography mode has a large aperture and a low shutter speed corresponding to the photography of such a dark subject as a night view, or the photography of a main subject as people against night scenes or dark indoors as a background. When the operation member 15 is in the first operating position, the first photography mode is selected. When the operation member 15 is in the second position, the second photography mode is selected.

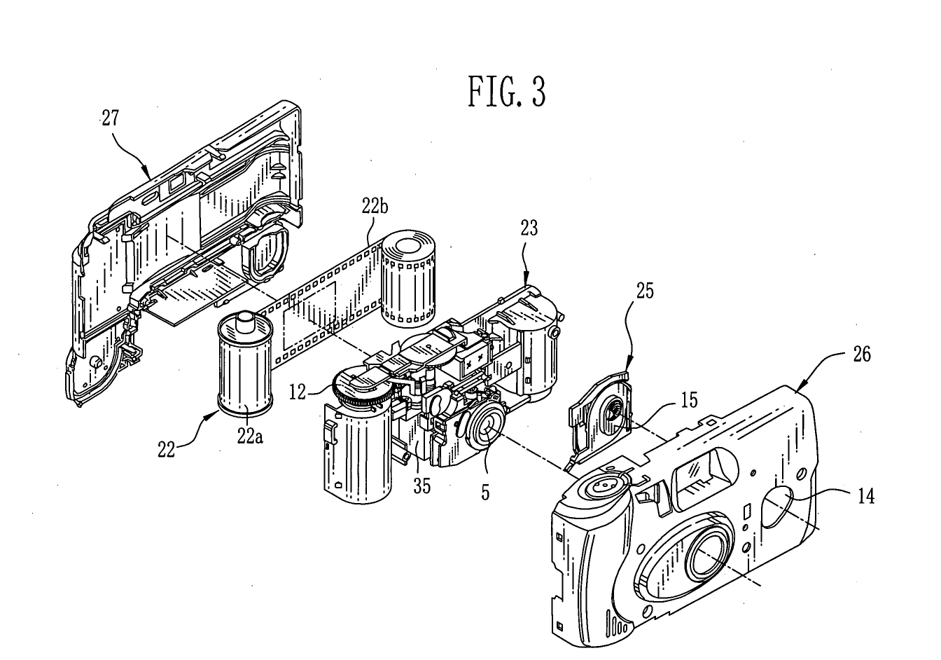

As shown in FIG. 3, the unit body 3 is constituted by a body base 23 in which a film cartridge 22 of a 135 type is loaded, a photography mode changeover mechanism 25 for changing the photography mode, a front cover 26 and a rear cover 27 attached respectively to the front and the rear of the body base 23.

The film cartridge 22 includes a cartridge 22a and a photo film 22b, and is loaded at the time of manufacturing, as described above. As for the photo film 22b, a color negative film of ISO 3200 type is used. In relation to a film sensitivity, ISO 1600 or higher is preferable, and ISO 3200 or higher is more preferable.

At the center in the front face of the body base 23, a light-shielding box 35 is disposed. Around the light-shielding box 35 is with attached a shutter charge mechanism, a shutter mechanism, a film winding mechanism, a film winding stop mechanism, a film counting mechanism, a stop changeover mechanism, a shutter speed shifting mechanism, a photographic optical system, a finder optical system, and the like.

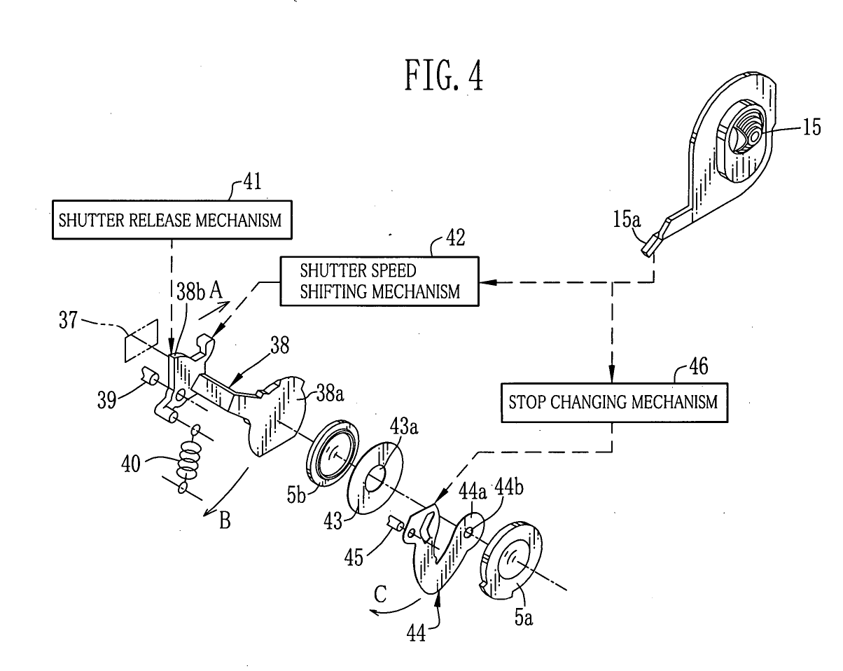

As shown in FIG. 4, an exposure opening 37 is formed in the front face of the light-shielding box 35. A shutter blade 38 constituting the shutter mechanism is pivotable around a shaft 39. The shutter blade 38 is biased by a spring 40 to a closed position for closing the exposure opening 37 with a blade portion 38a.

A shutter release mechanism 41 kicks a protruding portion 38b of the shutter blade 38 toward the direction of an arrow A in the drawing, in response to the pressing operation of the shutter release button 9. The kicked shutter blade 38 pivots toward the direction of an arrow B in the drawing against the bias of the spring 40, and fully opens the exposure opening 37. After this, the shutter blade 38 returns to the closed position by the bias of the spring 40.

A shutter speed shifting mechanism 42 is operated in cooperation with a interlock lever 15a formed to be integrated with the operation member 15, and serves to shift the shutter speed either the high speed or low speed in response to the operating position of the operation member 15. When the operation member 15 is in the first operating position, the shutter speed shifting mechanism 42 sets to the high shutter speed by reducing the rotating angle of the shutter blade 38. When the operation member 15 is in the second operating position, the shutter speed shifting mechanism 42 sets to the low shutter speed by increasing the rotating angle of the shutter blade 38. In this embodiment, the high shutter speed is 1/100 second, and the low shutter speed is 1/45 second.

The taking lens 5 comprises a first lens 5a and a second lens 5b. Between the first lens 5a and the second lens 5b, a large aperture stop plate 43 is disposed. The large aperture stop plate 43 is a thin circular plate, and a large aperture 43a with a large diameter is formed at the center thereof. The large aperture 43a serves for the second photography mode, and is determined the diameter thereof to have an f-stop number of f 4.0.

A stop changeover plate 44 has one end provided with a small aperture stop portion 44a of the adequate size for closing the large aperture 43a. A small aperture 44b with a small diameter is formed in the small aperture stop portion 44a. The small aperture 44b serves for the first photography mode, and is determined the diameter thereof to have an f-stop number of f 16. The stop changeover plate 44 is pivotable around a shaft 45, between an inserting position for disposing the small aperture stop portion 44a within a photographic optical path, and a retreat position retreated from the inserting position toward the direction of an arrow C in the drawing. When the stop changeover plate 44 is in the inserting position, the photographic light is to pass through the large aperture 43a and the small aperture 44b. Consequently, the light amount is limited by the small aperture 44b with the small diameter.

A stop changeover mechanism 46 is operated in cooperation with the interlock lever 15a, as with the shutter speed shifting mechanism 42, to rotate the stop changeover plate 44 in response to the operating position of the operation member 15. When the operation member 15 is in the first operating position, the stop changeover mechanism 46 puts the stop changeover plate 44 in the inserting position. When the operation member 15 is in the second operating position, the stop changeover plate 44 is put in the retreat position.

The photo film 22b is a commercially available type, and can be loaded in other types of the lens-fitted photo film unit. In the photo film 22b loaded in the lens-fitted photo film unit 2, flashless information is provided (recorded) at the time of manufacturing, which indicates the photography without using assist light, such as flash light.

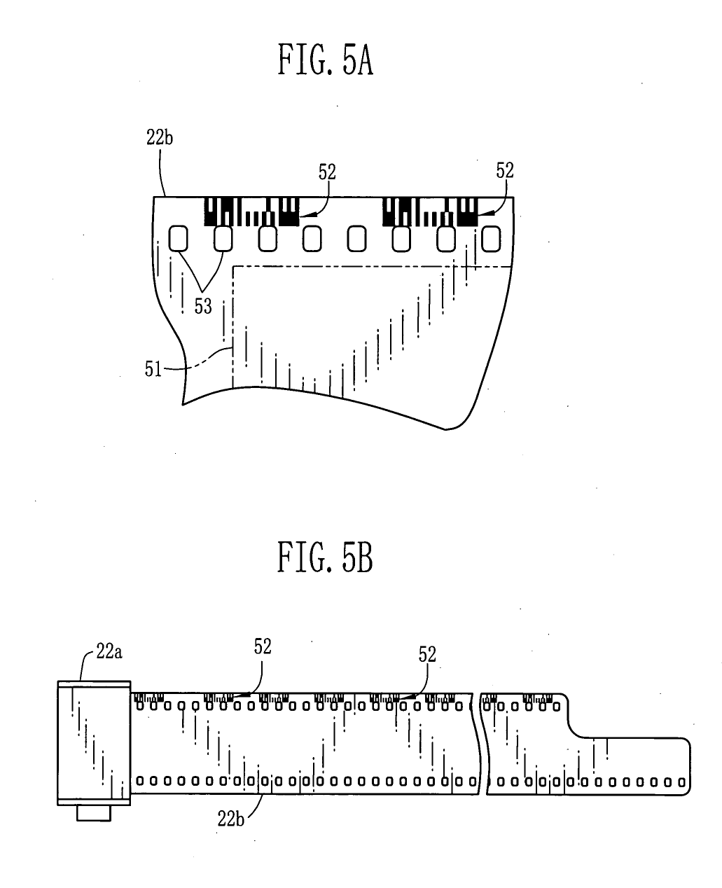

As depicted in FIG. 5A, a bar code 52 is optically recorded outside an exposure area 51 of the photo film 22b as a latent image at the time of manufacturing. The bar code 52 is visualized by developing. In the present embodiment, the bar code 52 is a known DX coding for a general photo film, which includes coded information of a photo film manufacturer, a film type, a lot number, and the like. The film type information further contains the flashless information in the present invention. A plurality of the bar codes 52 is recorded at the proper intervals on one photo film, as shown in FIG. 5B, so that it is possible to be read when the photo film 22b is partitioned every proper number of frames after developing. A numeral 53 in the drawing is perforations.

In the photo film 22b loaded in the lens-fitted photo film unit 2 described above, the bar code 52 includes the coded film type information representing a particular film type which is different from the film type commercially available or loaded in other types of the lens-fitted photo film unit. Thus, flashless information is contained in the film type information and provided to the photo film 22b loaded in the lens-fitted photo film unit 2.

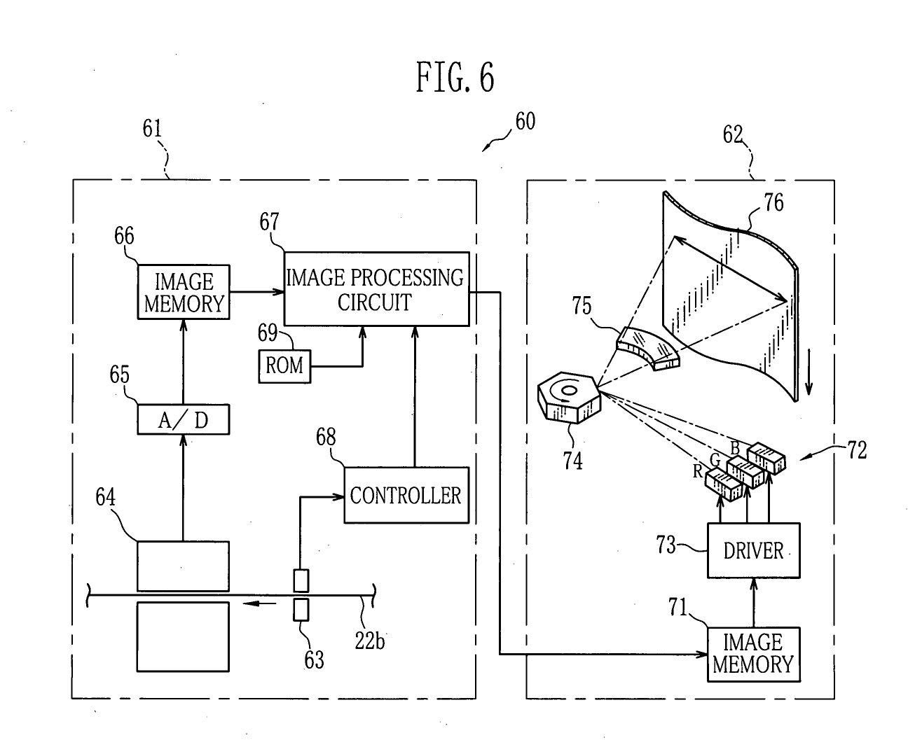

As shown in FIG. 6, a digital printer 60 has an input section 61 and an output section 62. The input section 61 is constituted by a bar code sensor 63 for reading the bar code on the exposed photo film 22b, a scanner 64 for reading a color image from each picture frame of the photo film 22b, an A/D converter 65, an image memory 66, an image processing circuit 67, and a controller 68 for controlling those above.

The exposed photo film 22b is transported to the scanner 64 by a transportation mechanism not shown in the drawings. In this transportation, the bar code sensor 63 reads the bar code 52 on the photo film 22b. The bar code 52 being read is transmitted to the controller 68. On the basis of the bar code 52, the controller 68 controls the image processing circuit 67.

The scanner 64 includes a film carrier, a lamp, a diffusion box for diffusing the light from the lamp to illuminate the picture frames set in the film carrier, an image sensor (CCD) for reading the picture frames, the lens for forming a color image of each picture frame on the image sensor and the like, which are not shown in the drawings. Every time one frame of the photo film 22b is advanced, the scanner 64 performs the three-color separation photometry of the color image by the image sensor, and transmits the photoelectric signal being obtained thereby to the A/D converter 65.

The A/D converter 65 converts the color image of the picture frame into the three-color image data, by the digital conversion of each analog photoelectric signal. The three-color image data is written into the image memory 66. When the image data of one photo film is written into the image memory 66, the image processing circuit 67 reads it out and performs the predetermined image processing under the control of the controller 68. As for the image processing performed by the image processing circuit 67, there are a color correction, a density correction, a Y correction and the like. After being applied the image processing, the image data is output to the image memory 71 in the output section 62.

In a ROM 69, a Look-Up Table (LUT) of a color correction for the flashless photography is written. The LUT of the color correction is a density conversion table of the color correction for converting the density of each color in the image data, so as not to color the achromatic subject which is photographed outdoors in daylight with using the photo film 22b of the daylight type. The LUT is determined in accordance with the characteristics of the photo film 22b. It is preferable that a plurality of LUTs of the color correction for respective types of the photo film having the different coloring characteristics is prepared in the ROM 69, and also each photo film is provided with the film type information peculiar to each type. For this configuration, different types of the photo film with the flashless information can be applied a proper color correction according to their particular film type information.

The image processing circuit 67 applies the color correction with using the LUT for the color correction in the ROM 69, to the photographed image from the photo film 22b wherein the bar code 52 includes the flashless information is recorded. In relation to the photographed image of the normal photo film without the flashless information, the image processing circuit 67 performs an ordinary operation for printing, for example, a color correction by a statistical arithmetic processing based on the image data of all the photographic images in one photo film.

The output section 62 is constituted by the image memory 71, a laser unit 72 for emitting each laser beam of three colors, a driver 73 for controlling the emission of the laser unit 72 in accordance with the image data of the image memory 71, a polygon mirror 74, a Fθ lens 75, a transportation mechanism (not shown) for conveying long lengths of a color photographic paper 76, and the like.

While the color photographic paper 76 is conveyed by the transportation mechanism in the lengthwise direction thereof, the image of each picture frame is printed to the color photographic paper 76 by scanning of laser beam with the polygon mirror 74 rotating at a high speed. The exposed color photographic paper is cut off every frame after developing, to produce photographic prints.

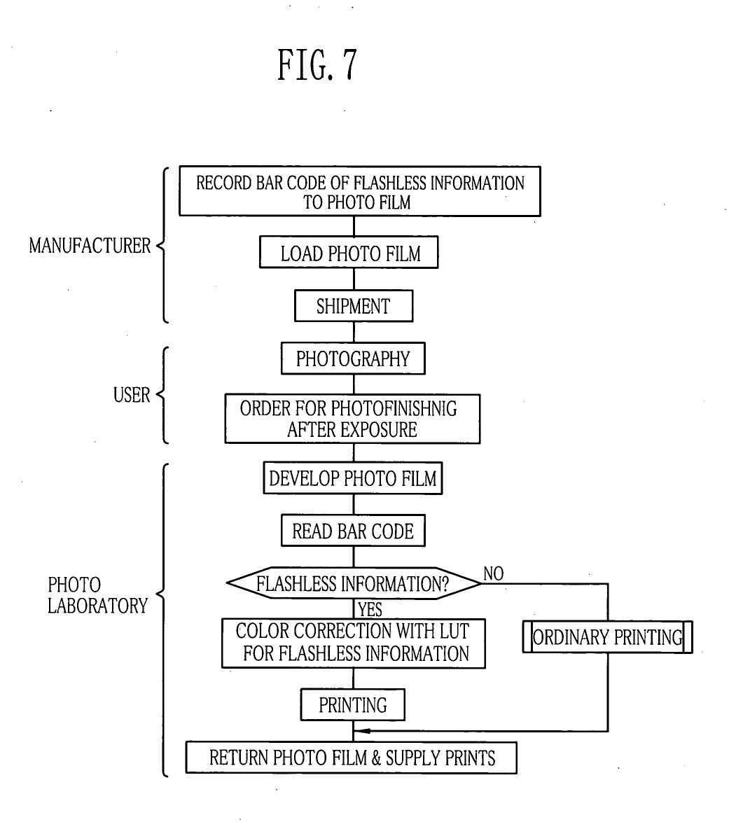

Next, the operation of the above constitution is described. As depicted in FIG. 7, at the time of manufacturing, the bar code 52 including the flashless information is recorded as a latent image in the photo film 22b for being loaded in the lens-fitted photo film unit 2.

The photo film 22b provided with the bar code 52 is loaded in the unit body 3 with the cartridge 22a. The lens-fitted photo film unit 2, wherein the label 4 is attached to the completed unit body 3, is shipped and provided to the user for photography.

When the photography is conducted in the bright light such as outdoors in the daytime, the first photography mode is selected. In order to select the first photography mode, it is required to set the operation member 15 at the first operating position, as shown in FIG. 1. This operation serves to set the small aperture and the high shutter speed, and then the exposure is performed to the photo film 22b by pressing the shutter release button 9.

On the other hand, in the case of photographing such a dark subject as the night view or photographing such a main subject as people against the indoors as a background, the operation member 15 is turned to the second operating position from the first operating position to select the second photography mode, as depicted in FIG. 2. According to this, the large aperture and the low shutter speed are set, and then the exposure is performed to the photo film 22b by pressing the shutter release button 9.

The flash light is not illuminated to the subject in either photographic mode, therefore, the photo film 22b is exposed by available light at the time of photographing.

After photographing all the frames, the user takes the lens-fitted photo film unit 2 to a photo laboratory or a photo shop. In the photo laboratory or the like, the cartridge 22a containing the exposed photo film 22b is taken out from the unit body 3.

The photo film unit 22b is extracted from the cartridge 22a and put into the predetermined developing unit to be applied the color development, and then set into the digital printer 60. The digital printer 60 extracts the developed photo film 22b and advances the leading end thereof toward the scanner 64.

During the transportation, the bar code sensor 63 reads the bar code 52 visualized by the development on the edge portion of the photo film 22b, and the controller 68 decodes it. On the basis of the bar code 52, it is judged whether the photo film 22b is provided with the flashless information or not. The judgment depends on whether the film type information decoded from the bar code 52 is for the flashless photography or not. Also, when the bar code is not recorded, it is judged that the flashless information is not provided.

If it is judged that the photo film 22b is provided with the flashless information in the processing of the photo film 22b, the controller 68 controls the image processing circuit 67 so as to perform the color correction with using the LUT of the color correction written in the ROM 69.

When the first picture frame is set into the negative film carrier in the scanner 64, the image sensor reads a color image of the picture frame, and then the three-color image data is written into the image memory 66 through the A/D converter 65. After this, the second picture frame is set into the negative film carrier in the scanner 64. In the same manner, each color image of the second and following picture frames is read, and the image data thereof is written into the image memory 66.

After the image data of all the picture frames in the photo film 22b is written into the image memory 66, the image data of every one frame is read out from the image memory 66 by the image processing circuit 67. Then, the color correction, the density correction, and the Y correction and the like are sequentially applied to the image data. At this time, the color correction is performed by converting the density of each color in the image data, with using the LUT of the color correction in the ROM 69, under the instruction of the controller 68.

After the processing in the image processing circuit 67 is completed, the image data being processed is written sequentially into the image memory 71 of the output section 62. After this, on the basis of the image data in the image memory 71, the laser unit 72 is operated by the driver 73 to record a photographed image of each picture frame sequentially on the color photographic paper 76 as a latent image.

After being exposed in such a manner as described above, the color photographic paper 76 undergoes a color developing process. After developing, fixing and drying, each image of the color photographic paper 76 is cut off and fed out from the digital printer 60.

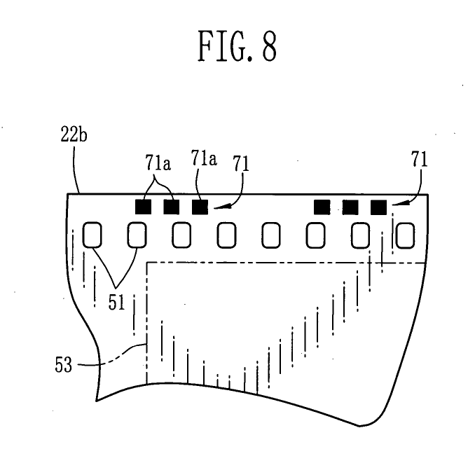

In the above embodiment, the film type information contains the flashless information, and the photo film is provided with the bar code of the DX coding scheme, representing various kinds of coded information including the film type information. However, the flashless information may be recorded on the photo film in another manner. For example, as shown in FIG. 8, three dot marks 71a indicating the flashless information 71 are recorded as a latent image at the time of manufacturing. In addition, when the photo film is provided with the flashless information, it may perform no color correction to produce a photographic print.

Although the present invention has been fully described by way of the preferred embodiments thereof with reference to the accompanying drawings, various changes and modifications will be apparent to those having skill in this field. Therefore, unless otherwise these changes and modifications depart from the scope of the present invention, they should be construed as included therein.

What is claimed is:

1. A lens-fitted photo film unit, wherein an unexposed photo film is loaded in a unit body incorporating photographic mechanisms at the time of manufacturing, said lens-fitted photo film unit comprising:
flashless information, optically prerecorded outside an exposure area on said photo film, for indicating that said photo film is for the photography without using a flashlight emitting unit.

2. A lens-fitted photo film unit as defined in claim 1, wherein said flashless information is recorded with a bar code.

3. A lens-fitted photo film unit as defined in claim 1, wherein said flashless information is recorded with a dot mark.

4. A lens-fitted photo film unit as defined in claim 1, wherein said photo film has a film sensitivity of ISO 1600 or higher.

5. A lens-fitted photo film unit as defined in claim 1, wherein said photo film has a film sensitivity of ISO 3200 or higher.

6. A method of producing a photographic print from a photo film by a printer comprising the steps of:
searching flashless information recorded on said photo film, for indicating that said photo film is for the photography without using a flashlight emitting unit; and
performing a predetermined color correction for said flashless photography when said flashless information is detected.

7. A method of producing a photographic print from a photo film by a printer comprising the steps of:
searching flashless information recorded on said photo film, for indicating that said photo film is for the photography without using a flashlight emitting unit; and
performing a color correction with using a predetermined conversion table of a color correction for said flashless photography, when said flashless information is detected.
